(19) United States
(12) Patent Application Publication
(10) Pub. No.: US 2026/0010190 A1
(43) Pub. Date: Jan. 8, 2026

(54) BANDGAP REFERENCE VOLTAGE GENERATION CIRCUIT HAVING HIGH-ORDER TEMPERATURE COMPENSATION

(71) Applicant: Richtek Technology Corporation, Hsinchu (TW)

(72) Inventors: Hong-Wei FU, Kaohsiung (TW); Chia-Tseng CHIANG, New Taipei (TW); Chung-Chih HUNG, Hsinchu (TW); Jui-Chih CHIEN, Taoyuan (TW)

(21) Appl. No.: 19/257,396

(22) Filed: Jul. 1, 2025

Related U.S. Application Data
(60) Provisional application No. 63/667,142, filed on Jul. 3, 2024.

(30) Foreign Application Priority Data
Mar. 7, 2025 (TW) 114108593

(51) Int. Cl. G05F 3/26

(52) U.S. Cl. CPC G05F 3/265

(57) ABSTRACT

A bandgap reference voltage generation circuit includes two bipolar junction transistors biased at different current densities to generate a base-emitter voltage difference, and to determine a negative temperature coefficient current. The circuit further includes a delta-voltage sensing resistor and a feedback circuit to ensure that the voltage drop across the delta-voltage sensing resistor includes the voltage difference, thereby generating a positive temperature coefficient current. The positive and negative temperature coefficient currents are combined to bias an output resistor, generating an output current with low-order temperature compensation. A multi-stage compensation circuit further generates a compensation current, which is injected into a tap of the output resistor to form a bandgap reference voltage with high-order temperature compensation. The compensation current varies with temperature and exhibits at least three stages of temperature coefficient.

### CROSS REFERENCE

The present invention claims priority to provisional application 63/667,142 filed on Jul. 3, 2024, and TW 114108593 filed on Mar. 7, 2025.

### BACKGROUND OF THE INVENTION

### Field of Invention

The present invention relates to a bandgap reference voltage generation circuit, and more particularly to a bandgap reference voltage generation circuit having high-order temperature compensation.

### Description of Related Art

Please refer to FIG. 1, which is a schematic diagram of a bandgap reference voltage generation circuit of the prior art. In this circuit, bipolar junction transistors Q1 and Q2 are transistors with different current densities or area ratios, used to generate a positive temperature coefficient current and a negative temperature coefficient current. An amplifier detects a voltage difference across the bipolar junction transistors Q1 and Q2 and enforces this voltage difference across a delta-voltage sensing resistor R1, thereby forming a positive temperature coefficient current. This current is then combined with the negative temperature coefficient current at the load of the output terminal to achieve low-order (e.g., first-order) temperature compensation.

However, the compensation circuit relies on resistors to control the temperature compensation. The relationship of the bandgap reference voltage VREF is shown as follows:

$$V R E F = V B E Q 3 + \frac{VT ln ( n ) ( R 2 + R 3 )}{R 2} + INL \times R 2$$

In this equation, INL×R2 is a compensation term, and,

$$VBEQ 3 + \frac{VT ln ( n ) ( R 2 + R 3 )}{R 2}$$

represents low-order temperature compensation.

Considering the impact of process variations, the bandgap reference voltage VREF may significantly drift with temperature or batch differences under different process corners. Therefore, the prior art may fail to achieve the goal of a high-precision bandgap reference voltage. In other words, reducing the impact of process variation is a major challenge faced by this architecture.

In view of the above deficiencies of the prior art, the present invention provides a bandgap reference voltage generation circuit with low temperature coefficient and high precision, which can robustly overcome various process variations.

### SUMMARY OF THE INVENTION

From one perspective, the present invention provides a bandgap reference voltage generation circuit, comprising: a first bipolar junction transistor, biased with a first current density, configured to determine a first negative temperature coefficient current; a second bipolar junction transistor, biased with a second current density, wherein the first current density is greater than the second current density, such that base-emitter voltages of the first bipolar junction transistor and the second bipolar junction transistor are different, thereby exhibiting a base-emitter voltage difference; a delta-voltage sensing resistor, connected in series with the second bipolar junction transistor from a supply potential to form a sub-branch; a first feedback circuit, configured to control a first voltage drop across the sub-branch to be equal to the collector-emitter voltage of the first bipolar junction transistor, such that a second voltage drop across the delta-voltage sensing resistor includes the base-emitter voltage difference, thereby determining a first positive temperature coefficient current, wherein the first positive temperature coefficient current and the first negative temperature coefficient current are superimposed to form an output current exhibiting a low-order temperature compensation characteristic, wherein the output current is configured to bias an output resistor, such that a bandgap reference voltage formed across the output resistor includes the low-order temperature compensation characteristic accordingly; and a multi-segment compensation circuit, configured to generate a compensation current based on the first positive temperature coefficient current and the first negative temperature coefficient current, and to inject the compensation current into a tap of the output resistor, thereby enabling the bandgap reference voltage to further exhibit a high-order temperature compensation characteristic; wherein the compensation current has at least three temperature variation slopes, and the at least three temperature variation slopes increase as temperature increases.

In one preferred embodiment, the multi-segment compensation circuit comprises first to N-th positive temperature coefficient sub-compensation circuits and first to N-th negative temperature coefficient sub-compensation circuits, where N is greater than or equal to 1; wherein each of the first to N-th positive temperature coefficient sub-compensation circuits includes: a base positive temperature coefficient current source, configured to generate a base positive temperature coefficient current, wherein the base positive temperature coefficient current is positively correlated with the first positive temperature coefficient current; a gain-amplified negative temperature coefficient current source, configured to generate a gain-amplified negative temperature coefficient current, which is positively correlated with the first negative temperature coefficient current; and a first differential mirroring circuit, configured to unidirectionally output a positive temperature coefficient sub-current, which is positively correlated with a difference between the base positive temperature coefficient current and the gain-amplified negative temperature coefficient current; wherein, when N is plural, the gain-amplified negative temperature coefficient currents of the first to N-th positive temperature coefficient sub-compensation circuits are different from each other; wherein each of the first to N-th negative temperature coefficient sub-compensation circuits includes: a base negative temperature coefficient current source, configured to generate a base negative temperature coefficient current, wherein the base negative temperature coefficient current is positively correlated with the first negative temperature coefficient current; a gain-amplified positive temperature coefficient current source, configured to generate a gain-amplified positive temperature coefficient current, which is positively correlated with the first positive temperature coefficient current; and a second differential mirroring circuit, configured to unidirectionally output a negative temperature coefficient sub-current, which is positively correlated with a difference between the base negative temperature coefficient current and the gain-amplified positive temperature coefficient current; wherein, when N is plural, the gain-amplified positive temperature coefficient currents of the first to N-th negative temperature coefficient sub-compensation circuits are different from each other; wherein the compensation current is a sum of: the respective positive temperature coefficient sub-currents of the first to N-th positive temperature coefficient sub-compensation circuits; and the respective negative temperature coefficient sub-currents of the first to N-th negative temperature coefficient sub-compensation circuits.

In one preferred embodiment, the respective positive temperature coefficient sub-currents of the first to N-th positive temperature coefficient sub-compensation circuits drop to zero at first temperature thresholds respectively; and the respective negative temperature coefficient sub-currents of the first to N-th negative temperature coefficient sub-compensation circuits drop to zero at second temperature thresholds respectively; wherein the first temperature thresholds are lower than the second temperature thresholds.

In one preferred embodiment, the bandgap reference voltage generation circuit further comprises a calibration control circuit, configured to measure a current gain in a test mode, wherein the current gain is related to current gain characteristic of at least one of the first bipolar junction transistor and the second bipolar junction transistor; wherein the calibration control circuit is further configured to adjust a resistance value of the delta-voltage sensing resistor in an operation mode for further temperature compensation of the bandgap reference voltage.

In one preferred embodiment, in a first test phase under the test mode, a test current is provided to a base of a test bipolar junction transistor, and a first phase voltage is generated by biasing a test resistor through a collector current of the test bipolar junction transistor; wherein in a second test phase under the test mode, the test current is configured to bias the test resistor to generate a second phase voltage, and the current gain is a ratio of the first phase voltage to the second phase voltage; wherein the test bipolar junction transistor corresponds to the first bipolar junction transistor, the second bipolar junction transistor, or another bipolar junction transistor of the same type as the first bipolar junction transistor and the second bipolar junction transistor.

In one preferred embodiment, the first feedback circuit includes a first amplifier circuit, and an offset of the first amplifier circuit is reduced by a chopper circuit.

In one preferred embodiment, the first feedback circuit further includes a current mirror circuit and a dynamic element matching circuit, and the current mirror circuit is controlled by the first amplifier circuit to mirror currents between the first bipolar junction transistor and the second bipolar junction transistor, wherein the dynamic element matching circuit is configured to perform dynamic matching on the current mirror circuit to reduce an error of the current mirror circuit.

In one preferred embodiment, the output resistor includes an adjustable sub-resistor, configured to calibrate a level of the bandgap reference voltage.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a bandgap reference voltage generation circuit of the prior art.

FIG. 2 shows a schematic diagram of a bandgap reference voltage generation circuit according to one embodiment of the present invention.

The upper-left portion of FIG. 3 schematically illustrates a concave temperature curve that may result after low-order temperature compensation. The lower-left portion of FIG. 3 shows a compensation current with multiple temperature thresholds. The right half of FIG. 3 illustrates superimposed compensation of the bandgap reference voltage by the multi-threshold compensation current.

FIG. 4A shows a generation mechanism of the multi-segment compensation current in the high-temperature region.

FIG. 4B shows a generation mechanism of the multi-segment compensation current in the low-temperature region.

[symbol]

sub

[symbol]

FIG. 4C shows curves exhibiting the variations of multi-segment positive temperature coefficient sub-currents and negative positive temperature coefficient sub-currents with respect to temperature.

FIGS. 5A and 5B show schematic diagrams of specific embodiments of the multi-segment compensation circuit in the bandgap reference voltage generation circuit according to the present invention.

FIG. 6A illustrates the distribution of the input offset voltage of the amplifier circuit with respect to temperature when the chopper circuit is not activated.

FIG. 6B illustrates the distribution of the input offset voltage of the amplifier circuit with respect to temperature after the chopper circuit is activated.

FIG. 7 shows a partial schematic diagram of a calibration control circuit of the bandgap reference voltage generation circuit according to one embodiment of the present invention.

FIG. 8 illustrates one specific embodiment of the delta-voltage sensing resistor.

FIG. 9A shows the bandgap reference voltage before calibrating the current gain β of the bipolar junction transistor using a test mode and fine-tuning the delta-voltage sensing resistor.

FIG. 9B shows the bandgap reference voltage of chips from the same batch after measuring the current gain and adjusting the delta-voltage sensing resistor accordingly.

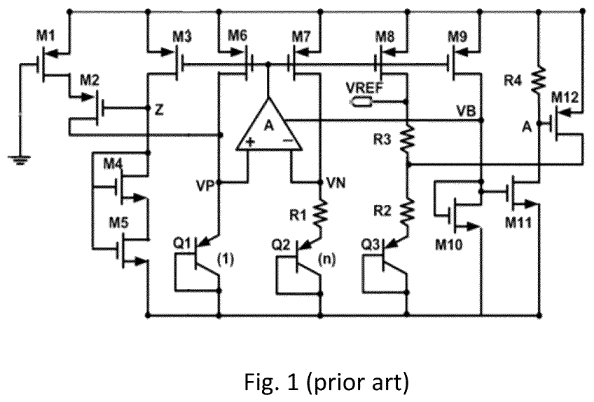

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

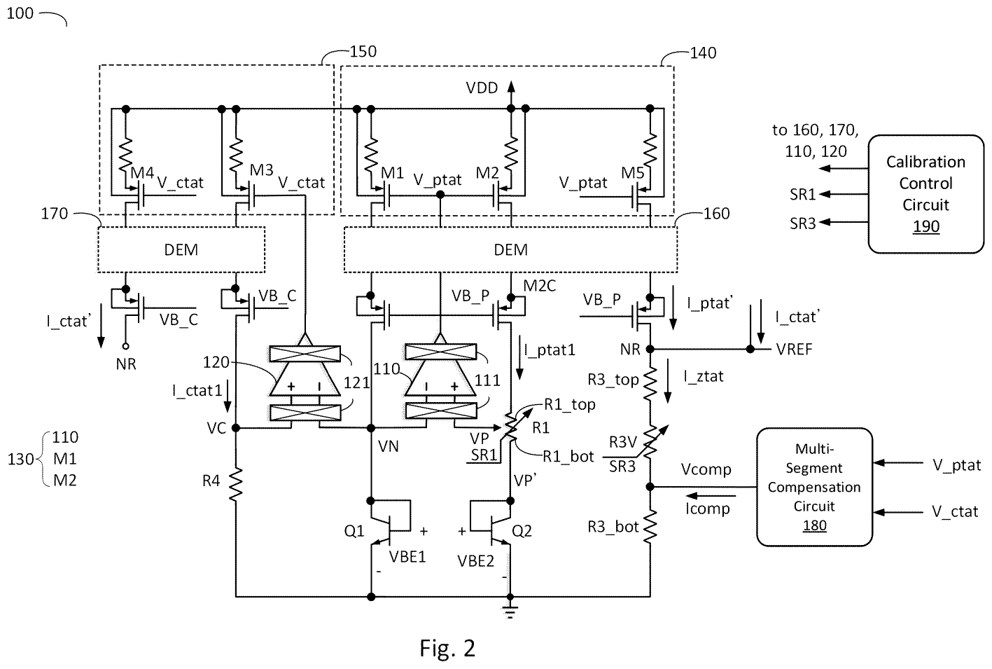

Please refer to FIG. 2. FIG. 2 illustrates a schematic diagram of a bandgap reference voltage generation circuit according to an embodiment of the present invention. As shown in FIG. 2, the bandgap reference voltage generation circuit 100 of the present invention includes bipolar junction transistor Q1 and bipolar junction transistor Q2, amplifier circuits 110 and 120, feedback circuit 130, current mirror circuits 140 and 150, dynamic element matching circuits (DEM) 160 and 170, multi-segment compensation circuit 180, and calibration control circuit 190. The bipolar junction transistor Q1 and the bipolar junction transistor Q2 are configured to form a current I_ctat1 having a negative temperature coefficient and a current I_ptat1 having a positive temperature coefficient, respectively. In FIG. 2, the bipolar junction transistor Q1 is biased at a higher current density, while the bipolar junction transistor Q2 is biased at a lower current density, thereby exhibiting a difference (base-emitter voltage difference) between the base-emitter voltages of Q1 and Q2. The bipolar junction transistor Q2 is connected in series, sequentially from a supply potential (e.g., ground), with a delta-voltage sensing resistor R1 to form a sub-branch. The feedback circuit 130 operates in a feedback configuration such that the voltage drop across this sub-branch equals the collector-emitter voltage of the bipolar junction transistor Q1, thereby causing the base-emitter voltage difference to appear across the delta-voltage sensing resistor R1, further generating the positive temperature coefficient currents I_ptat1 and I_ptat′ accordingly.

The amplifier circuit 120 and resistor R4 are configured to generate the negative temperature coefficient currents I_ctat1 and I_ctat′ based on the collector-emitter voltage of the bipolar junction transistor Q1. The positive temperature coefficient current I_ptat′ and the negative temperature coefficient current I_ctat′ are then summed and output to the output resistor R3, preliminarily generating a bandgap reference voltage VREF which includes a low-order temperature compensation characteristic accordingly.

The multi-segment compensation circuit 180 generates a compensation current Icomp based on the aforementioned positive temperature coefficient current I_ptat1 and the negative temperature coefficient current I_ctat1, and injects the compensation current into a tap of the output resistor R3, thereby generating a bandgap reference voltage VREF on the output resistor R3 that exhibits high-order (e.g., second or higher order) temperature compensation.

In addition, the amplifier circuits 110 and 120 may include chopper circuits (e.g., 111 or 112) to reduce the offset of the amplifier circuits, and cooperate with the dynamic element matching circuits 160 and 170 to reduce errors in the current mirror circuits. Adjustable sub-resistors may be provided on the output resistor R3 to finely tune the level of the bandgap reference voltage VREF.

As shown in FIG. 2, the feedback circuit 130 further comprises the current mirror circuit 140 and the dynamic element matching circuit 160. The current mirror circuit 140 is controlled by the amplifier circuit 110 to mirror the currents between the bipolar junction transistor Q1 and the bipolar junction transistor Q2, and is configured to mirror the positive temperature coefficient current I_ptat1 to generate the positive temperature coefficient current I_ptat′. The dynamic element matching circuit 160 performs dynamic element matching on the current mirror circuit 140, thereby reducing the error of the current mirror circuit 140. The current mirror circuit 150 is configured to mirror the negative temperature coefficient current I_ctat1 to generate the negative temperature coefficient current I_ctat′. The dynamic element matching circuit 170 performs dynamic element matching on the current mirror circuit 150 to reduce the error of the current mirror circuit 150.

The calibration control circuit 190 is configured to measure the current gain β under a test mode, which corresponds to the current gain characteristic at least one of the bipolar junction transistor Q1 and the bipolar junction transistor Q2. The calibration control circuit 190 is also configured to adjust the resistance value of the delta-voltage sensing resistor R1 during an operation mode to further calibrate the temperature coefficient of the bandgap reference voltage VREF, and to adjust the resistance value of the output resistor R3 during the operation mode to further calibrate the magnitude of the bandgap reference voltage VREF.

Please refer to FIG. 3. The upper left portion of FIG. 3 schematically illustrates an inverted bow-shaped curve that may be generated after low-order temperature compensation, which is the bandgap reference voltage VREF′ obtained by summing the negative temperature coefficient current I_ctat1 and the positive temperature coefficient current I_ptat1, and multiplying the result by the resistance value of the output resistor R3. The lower left portion of FIG. 3 shows a compensation current Icomp with multiple temperature thresholds. The right half of FIG. 3 shows the composite compensation of the bandgap reference voltage VREF′ by the compensation current Icomp with multiple temperature thresholds, which gradually flattens the curve and ultimately yields a bandgap reference voltage VREF with high-order temperature compensation.

In one embodiment, the compensation current Icomp with multiple temperature thresholds is generated based on the positive temperature coefficient current I_ptat1 and the negative temperature coefficient current I_ctat1, which are multiplied by different gains and then combined to form multiple sub-currents IL1 to IL3 and IH1 to IH3 having different temperature thresholds. In this embodiment, multiple temperature thresholds TthH1 to TthH3 and TthL1 to TthL3 are configured in the high-temperature and low-temperature regions, respectively. The positive temperature coefficient sub-currents IH1 to IH3 in the high-temperature region begin to be generated and exhibit positive temperature coefficients when the temperature exceeds their corresponding temperature thresholds TthH1 to TthH3 respectively. The negative temperature coefficient sub-currents IL1 to IL3 in the low-temperature region begin to be generated and exhibit negative temperature coefficients when the temperature falls below their corresponding temperature thresholds TthL1 to TthL3 respectively. All sub-currents are ultimately combined into a total compensation current Icomp and fed into a tap node of the output resistor R3 to cancel the residual inverted bow-shaped error from the low-order temperature compensation, thereby achieving the goal of high-order temperature compensation.

In one embodiment, the compensation current Icomp has at least three segments of temperature variation rates, wherein these temperature variation rates increase as the temperature increases. In one embodiment, the compensation current Icomp is symmetric with respect to a central temperature. In another embodiment, there is a flat region in the middle, i.e., the temperature coefficient of the compensation current Icomp is zero in this temperature range. In a preferred embodiment, the level of the compensation current Icomp is zero in this temperature range.

As shown in FIG. 3, the temperature thresholds (TthL1 to TthL3) where the negative temperature coefficient sub-currents IL1 to IL3 in the low-temperature region drop to zero are all lower than the temperature thresholds (TthH1 to TthH3) where the positive temperature coefficient sub-currents IH1 to IH3 drop to zero. As shown in the right half of FIG. 3, the final compensated curve of the bandgap reference voltage VREF, overall, has a temperature coefficient close to zero.

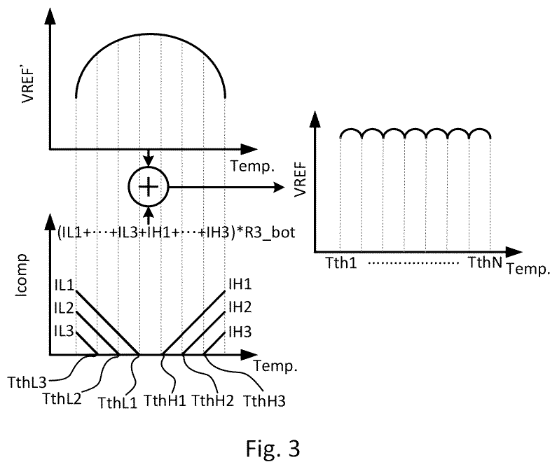

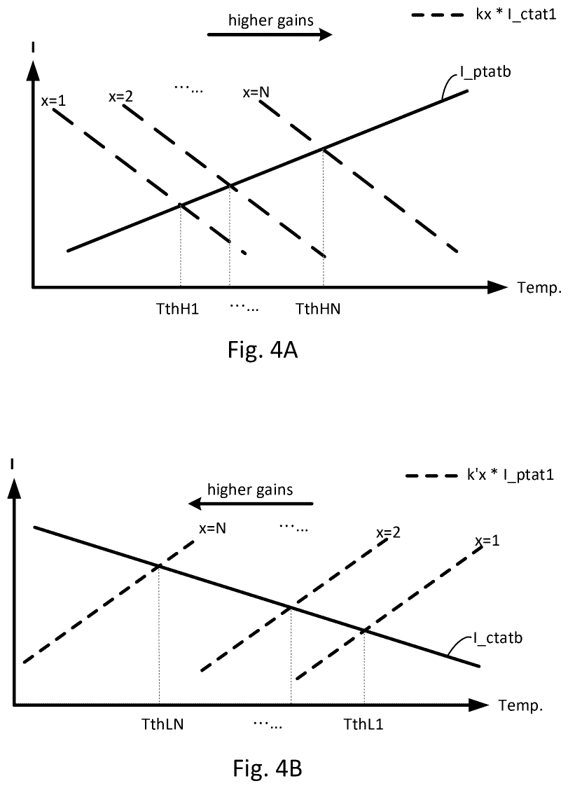

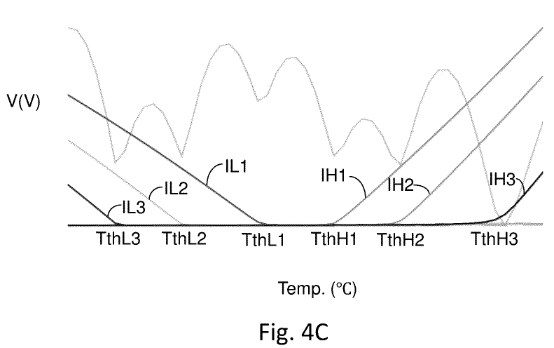

Please refer to FIG. 4A. FIG. 4A shows the generation method of multi-segment compensation currents in the high-temperature region. In this embodiment, each positive temperature coefficient sub-current IHx (x=1 to N, where N is a positive integer equal to or greater than 1) is formed by subtracting a gain-amplified negative temperature coefficient current I_ctatgx (which is the product of the negative temperature coefficient current I_ctat1 and a gain factor kx) from a base positive temperature coefficient current I_ptatb, and only the portion of the resulting current that is greater than or equal to zero is output. In other words, each positive temperature coefficient sub-current IH1 to IHN begins to output a positive current only after the temperature exceeds its corresponding predetermined temperature threshold TthH1 to TthHN. If the temperature has not yet reached the threshold and the resulting difference remains negative, the output current is limited to zero. This allows each high-temperature sub-current to turn on or off sequentially across different temperature regions, thereby correcting the residual error in the high-temperature section after the low-order temperature compensation in a segmented manner. The base positive temperature coefficient current I_ptatb is proportional to the positive temperature coefficient current I_ptat1, and the negative temperature coefficient current I_ctat2 is proportional to the negative temperature coefficient current I_ctat1.

Please refer to FIG. 4B. FIG. 4B illustrates the generation of compensation current in the low-temperature region using a corresponding method. In this embodiment, each negative temperature coefficient sub-current ILx is formed by subtracting a gain-amplified positive temperature coefficient current I_ptatgx (which is the product of the positive temperature coefficient current I_ptat1 and a gain factor k′x) from a base negative temperature coefficient current I_ctatb, and only the portion of the resulting current that is greater than or equal to zero is output. In other words, each negative temperature coefficient sub-current IL1 to ILN begins to output a positive current only after the temperature falls below its corresponding predetermined temperature threshold TthL1 to TthLN. If the temperature does not fall below the threshold, the resulting difference will be negative and the output current is limited to zero. This allows each low-temperature sub-current to turn on or off sequentially across different temperature regions, thereby correcting the residual error in the low-temperature section after the low-order temperature compensation in a segmented manner. The positive temperature coefficient current I_ptat3 is proportional to the positive temperature coefficient current I_ptat1, and the base negative temperature coefficient current I_ctatb is proportional to the negative temperature coefficient current I_ctat1.

Please refer to FIG. 4C. FIG. 4C schematically illustrates the temperature-dependent behavior of the multi-segment positive temperature coefficient sub-currents IH1 to IHN and negative temperature coefficient sub-currents IL1 to ILN along the temperature axis. The currents IHx in the high-temperature region start to rise after the temperature exceeds the corresponding temperature thresholds TthHx, while the currents ILx in the low-temperature region are activated once the temperature drops below the respective temperature thresholds TthLx. Ultimately, all compensation currents are combined and injected into a tap of the output resistor to cancel the inverted bow-shaped curve remaining after the low-order temperature compensation, thereby achieving a flatter bandgap reference voltage VREF across a wide temperature range.

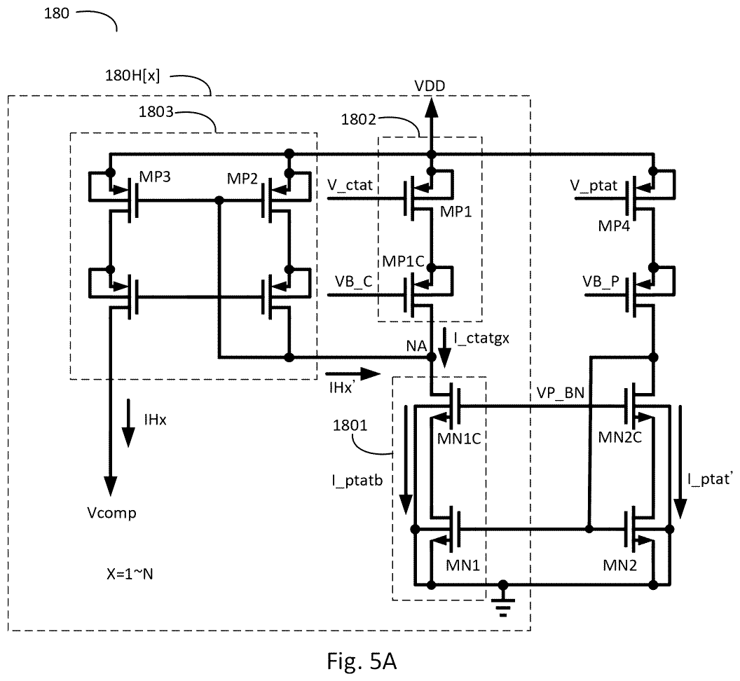

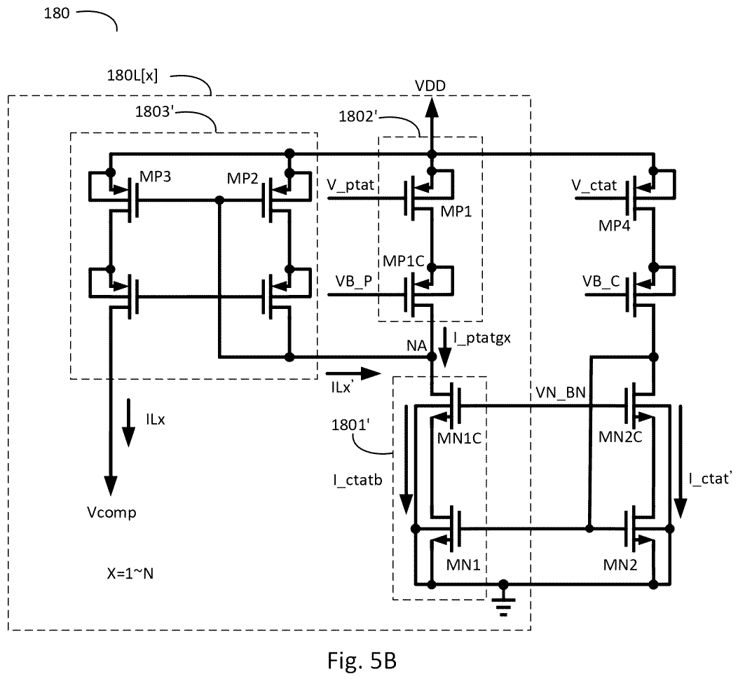

Please refer to FIG. 2, FIG. 5A, and FIG. 5B. FIG. 5A and FIG. 5B illustrate circuit schematics of specific embodiments of the multi-segment compensation circuit in the bandgap reference voltage generation circuit according to the present invention. As shown in FIG. 5A and FIG. 5B, in one embodiment, the multi-segment compensation circuit 180 may comprise multiple sub-compensation circuits configured to generate the aforementioned sub-currents IH1 to IHN and IL1 to ILN.

In the embodiment of FIG. 5A, a positive temperature coefficient sub-compensation circuit 180H[x] for the high-temperature region is used as an example for detailed explanation. As shown in FIG. 5A, each positive temperature coefficient sub-compensation circuit 180H[x] includes a base positive temperature coefficient current source 1801, a gain-amplified negative temperature coefficient current source 1802, and a differential mirror circuit 1803. Here, x=1 to N, where N is a positive integer equal to or greater than 1. The base positive temperature coefficient current source 1801 is configured to generate the base positive temperature coefficient current I_ptatb, which is generated based on a bias voltage V_ptat and is therefore positively correlated with the positive temperature coefficient current I_ptat1. In one specific embodiment, the base positive temperature coefficient current I_ptatb is proportional to the positive temperature coefficient current I_ptat1.

The gain-amplified negative temperature coefficient current source 1802 is configured to generate the gain-amplified negative temperature coefficient current I_ctatgx, which is generated based on a bias voltage V_ctat and is thus positively correlated with the negative temperature coefficient current I_ctat1. In a specific embodiment, the gain-amplified negative temperature coefficient current I_ctatgx is proportional to the negative temperature coefficient current I_ctat1, specifically I_ctatgx=kx×I_ctat1, where kx is the corresponding current gain. In one embodiment, N is plural, each current gain kx is different and is determined according to the required temperature threshold.

The differential mirror circuit 1803 is configured to output the positive temperature coefficient sub-current IHx unidirectionally. This sub-current is positively related to the difference between the base positive temperature coefficient current I_ptatb and the gain-amplified negative temperature coefficient current I_ctatgx, and only the portion of the resulting current greater than or equal to zero is output. In one embodiment, the positive temperature coefficient sub-current IHx is proportional to the difference between I_ptatb and I_ctatgx.

In the embodiment of FIG. 5B, a negative temperature coefficient sub-compensation circuit 180L[x] for the low-temperature region is used as an example for explanation. As shown in FIG. 5B, each negative temperature coefficient sub-compensation circuit 180L[x] includes a base negative temperature coefficient current source 1801′, a gain-amplified positive temperature coefficient current source 1802′, and a differential mirror circuit 1803′.

The base negative temperature coefficient current source 1801′ is configured to generate the base negative temperature coefficient current I_ctatb, and the gain-amplified positive temperature coefficient current source 1802′ is configured to generate the gain-amplified positive temperature coefficient current I_ptatgx. The gain-amplified positive temperature coefficient current I_ptatgx is proportional to the positive temperature coefficient current I_ptat1, specifically I_ptatgx=k′x×I_ptat1, where k′x is the corresponding current gain.

The differential mirror circuit 1803′ is configured to output the negative temperature coefficient sub-currents ILx unidirectionally. This sub-current is positively related to the difference between the base negative temperature coefficient current I_ctatb and the gain-amplified positive temperature coefficient current I_ptatgx, and only outputs a current greater than or equal to zero. In one embodiment, the negative temperature coefficient sub-current ILx is proportional to the difference between I_ctatb and I_ptatgx.

As previously described, when multiple sub-currents IHx and ILx are combined to generate a total compensation current Icomp, the resulting compensation effect as illustrated in FIG. 3 can be achieved.

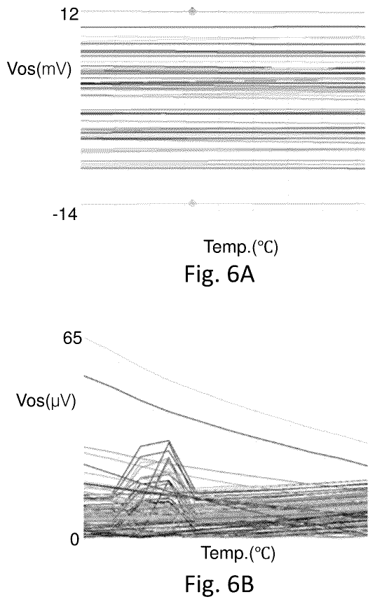

Please refer to FIG. 6A and FIG. 6B. FIG. 6A illustrates the distribution of the amplifier input offset voltage Vos with respect to temperature when the chopper circuits of amplifier circuits 110 and 120 are disabled. It can be seen that under different process batches or operating conditions, the offset voltage may reach the millivolt (mV) level. FIG. 6B shows the amplifier input offset voltage Vos when the chopper circuit is enabled. A clear concentration of the measurement curves at the microvolt (μV) level can be observed, indicating that the chopping circuit and its operation can effectively suppress the low-frequency and DC (direct current) offset voltage of the amplifier circuit, thereby allowing the bandgap reference voltage to maintain a small range of error under temperature and process variations.

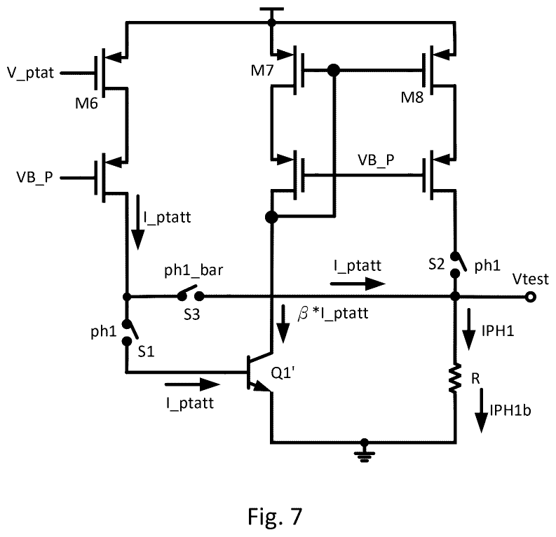

Please refer to FIG. 7. FIG. 7 illustrates a schematic of part of a calibration control circuit in the bandgap reference voltage generation circuit according to the present invention. Specifically, this embodiment shows a test circuit diagram for measuring the current gain β of a bipolar junction transistor under test. In the test mode, during a first test phase (i.e., when the phase signal ph1 is enabled), switches S1 and S2 are turned on, and switch S3 is turned off to provide a test current I_ptatt (which is proportional to the positive temperature coefficient current I_ptat1) to the base of the test bipolar junction transistor Q1′ under test. A first phase voltage is then generated by biasing a test resistor R with the collector current β×I_ptatt of the test bipolar junction transistor Q1′. In the second test phase of the test mode (i.e., when the phase signal ph1 bar is enabled), switch S3 is turned on, and switches S1 and S2 are turned off, allowing the test current I_ptatt to bias the test resistor R, resulting in a second phase voltage. The current gain β is obtained as the ratio of the first phase voltage to the second phase voltage, thereby determining the actual current gain of the bipolar junction transistor Q1 under test. Once the current gain β is acquired, the delta-voltage sensing resistor R1 can be finely adjusted prior to normal operation, ensuring that the bandgap reference voltage VREF does not exhibit significant deviation across the full temperature range and across process corners. In one embodiment, the test bipolar junction transistor Q1′ under test corresponds to bipolar junction transistors Q1 or Q2. In another embodiment, the test bipolar junction transistor Q1′ under test is another bipolar junction transistor of the same type as bipolar junction transistors Q1 and Q2.

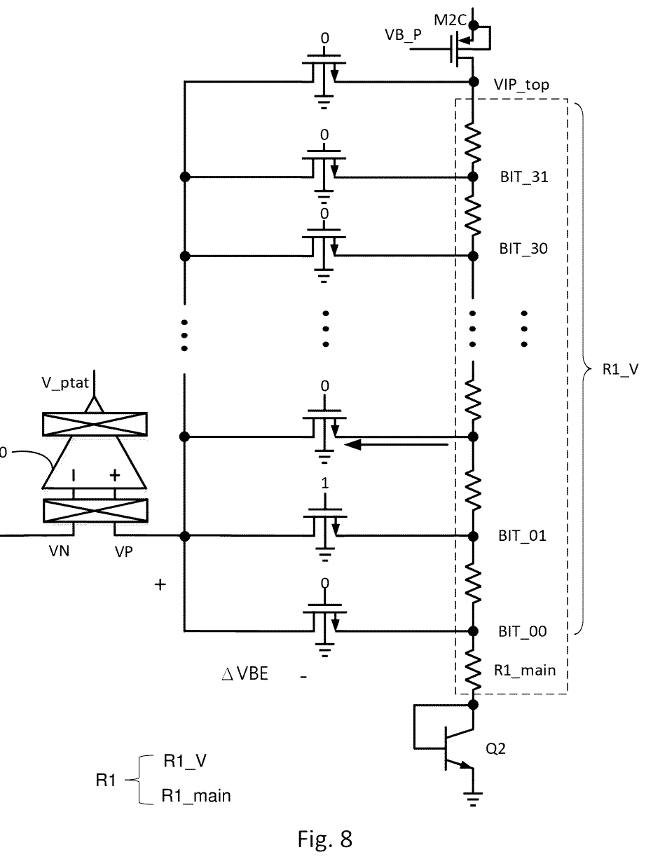

Please refer to FIG. 8. FIG. 8 illustrates a specific embodiment of the delta-voltage sensing resistor R1. In this embodiment, the calibration control circuit determines which switch to turn on based on the current gain β, thereby determining the resistance value of the effective resistance of the delta-voltage sensing resistor R1. This enables further correction of the temperature coefficient deviation of the bandgap reference voltage VREF caused by deviation in current gain β.

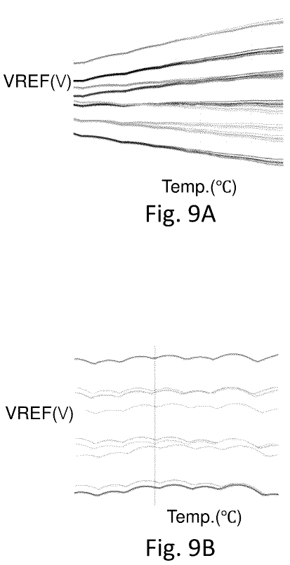

Please refer to FIG. 9A. FIG. 9A illustrates that prior to performing calibration in the test mode to measure the current gain β of the bipolar junction transistor and finely adjusting the delta-voltage sensing resistor R1, each temperature curve-even after multi-segment compensation—may still exhibit a positive or negative temperature coefficient due to the deviation of current gain β from its expected value. Please refer to FIG. 9B. FIG. 9B shows that after measuring the current gain β for the same batch of chips and adjusting the delta-voltage sensing resistor R1 accordingly, the temperature coefficients of each curve are significantly closer to zero.

In summary, the present invention achieves high-accuracy and low-temperature-coefficient bandgap reference voltage output characteristics across different process batches of the same manufacturing process by means of offset suppression, mismatch averaging, low-order and high-order temperature coefficient compensation, and calibration of the current gain of the bipolar junction transistor.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A bandgap reference voltage generation circuit, comprising:
a first bipolar junction transistor, biased with a first current density, configured to determine a first negative temperature coefficient current;
a second bipolar junction transistor, biased with a second current density, wherein the first current density is greater than the second current density, such that base-emitter voltages of the first bipolar junction transistor and the second bipolar junction transistor are different, thereby exhibiting a base-emitter voltage difference;
a delta-voltage sensing resistor, connected in series with the second bipolar junction transistor from a supply potential to form a sub-branch;
a first feedback circuit, configured to control a first voltage drop across the sub-branch to be equal to the collector-emitter voltage of the first bipolar junction transistor, such that a second voltage drop across the delta-voltage sensing resistor includes the base-emitter voltage difference, thereby determining a first positive temperature coefficient current, wherein the first positive temperature coefficient current and the first negative temperature coefficient current are superimposed to form an output current exhibiting a low-order temperature compensation characteristic, wherein the output current is configured to bias an output resistor, such that a bandgap reference voltage formed across the output resistor includes the low-order temperature compensation characteristic accordingly; and
a multi-segment compensation circuit, configured to generate a compensation current based on the first positive temperature coefficient current and the first negative temperature coefficient current, and to inject the compensation current into a tap of the output resistor, thereby enabling the bandgap reference voltage to further exhibit a high-order temperature compensation characteristic;
wherein the compensation current has at least three temperature variation slopes, and the at least three temperature variation slopes increase as temperature increases.

2. The bandgap reference voltage generation circuit according to claim 1, wherein the multi-segment compensation circuit comprises first to N-th positive temperature coefficient sub-compensation circuits and first to N-th negative temperature coefficient sub-compensation circuits, where N is greater than or equal to 1;
wherein each of the first to N-th positive temperature coefficient sub-compensation circuits includes:
a base positive temperature coefficient current source, configured to generate a base positive temperature coefficient current, wherein the base positive temperature coefficient current is positively correlated with the first positive temperature coefficient current;
a gain-amplified negative temperature coefficient current source, configured to generate a gain-amplified negative temperature coefficient current, which is positively correlated with the first negative temperature coefficient current; and
a first differential mirroring circuit, configured to unidirectionally output a positive temperature coefficient sub-current, which is positively correlated with a difference between the base positive temperature coefficient current and the gain-amplified negative temperature coefficient current;
wherein, when N is plural, the gain-amplified negative temperature coefficient currents of the first to N-th positive temperature coefficient sub-compensation circuits are different from each other;
wherein each of the first to N-th negative temperature coefficient sub-compensation circuits includes:
a base negative temperature coefficient current source, configured to generate a base negative temperature coefficient current, wherein the base negative temperature coefficient current is positively correlated with the first negative temperature coefficient current;
a gain-amplified positive temperature coefficient current source, configured to generate a gain-amplified positive temperature coefficient current, which is positively correlated with the first positive temperature coefficient current; and
a second differential mirroring circuit, configured to unidirectionally output a negative temperature coefficient sub-current, which is positively correlated with a difference between the base negative temperature coefficient current and the gain-amplified positive temperature coefficient current;
wherein, when N is plural, the gain-amplified positive temperature coefficient currents of the first to N-th negative temperature coefficient sub-compensation circuits are different from each other;
wherein the compensation current is a sum of:
the respective positive temperature coefficient sub-currents of the first to N-th positive temperature coefficient sub-compensation circuits; and
the respective negative temperature coefficient sub-currents of the first to N-th negative temperature coefficient sub-compensation circuits.

3. The bandgap reference voltage generation circuit according to claim 2, wherein:
the respective positive temperature coefficient sub-currents of the first to N-th positive temperature coefficient sub-compensation circuits drop to zero at first temperature thresholds respectively; and
the respective negative temperature coefficient sub-currents of the first to N-th negative temperature coefficient sub-compensation circuits drop to zero at second temperature thresholds respectively;
wherein the first temperature thresholds are lower than the second temperature thresholds.

4. The bandgap reference voltage generation circuit according to claim 1, further comprising a calibration control circuit, configured to measure a current gain in a test mode, wherein the current gain is related to current gain characteristic of at least one of the first bipolar junction transistor and the second bipolar junction transistor;
wherein the calibration control circuit is further configured to adjust a resistance value of the delta-voltage sensing resistor in an operation mode for further temperature compensation of the bandgap reference voltage.

5. The bandgap reference voltage generation circuit according to claim 4, wherein in a first test phase under the test mode, a test current is provided to a base of a test bipolar junction transistor, and a first phase voltage is generated by biasing a test resistor through a collector current of the test bipolar junction transistor;
wherein in a second test phase under the test mode, the test current is configured to bias the test resistor to generate a second phase voltage, and the current gain is a ratio of the first phase voltage to the second phase voltage;
wherein the test bipolar junction transistor corresponds to the first bipolar junction transistor, the second bipolar junction transistor, or another bipolar junction transistor of the same type as the first bipolar junction transistor and the second bipolar junction transistor.

6. The bandgap reference voltage generation circuit according to claim 1, wherein the first feedback circuit includes a first amplifier circuit, and an offset of the first amplifier circuit is reduced by a chopper circuit.

7. The bandgap reference voltage generation circuit according to claim 6, wherein the first feedback circuit further includes a current mirror circuit and a dynamic element matching circuit, and the current mirror circuit is controlled by the first amplifier circuit to mirror currents between the first bipolar junction transistor and the second bipolar junction transistor, wherein the dynamic element matching circuit is configured to perform dynamic matching on the current mirror circuit to reduce an error of the current mirror circuit.

8. The bandgap reference voltage generation circuit according to claim 1, wherein the output resistor includes an adjustable sub-resistor, configured to calibrate a level of the bandgap reference voltage.
